(19) United States
(12) Patent Application Publication
(10) Pub. No.: US 2015/0297443 A1
(43) Pub. Date: Oct. 22, 2015

(54) Substantially Upright Surface-Adhering Self Pleasure Device and Method

(71) Applicant: Neil L. MAURETTE, (US)

(72) Inventor: Neil L. MAURETTE, Calgary (CA)

(21) Appl. No.: 14/647,093

(22) PCT Filed: Nov. 29, 2013
(86) PCT No.: PCT/CA2013/050915

§ 371 Date: May 25, 2015

(30) Foreign Application Priority Data
Nov. 30, 2012 (CA) 2,797,665

(51) Int. Cl. A61H 19/00

(52) U.S. Cl. CPC A61H 19/32

(57) ABSTRACT

A substantially upright surface-adhering self pleasure device and method comprises at least one main body, at least one channel, at least one means of attachment and none, one or a plurality of protrusions, stabilizers, recesses, textures, and stimulators. This low complexity device, when adhered to a substantially upright surface, allows a male to perform safe and comfortable hands- free stimulation to the male genital. The device is generally constructed of a soft material to mimic the tactile feel of human flesh. This hands-free sexual aid device allows males who suffer from dexterity issues and or missing limbs an alternative, discrete and safe means to self pleasure.

### FIELD

This application relates to sexual aids; in particular, a substantially upright surface-adhering device allowing for discrete male self pleasure.

### BACKGROUND

There is little prior art pertaining to substantially upright surface-adhering sexual aid devices used by males for hands-free masturbation. The following demonstrates the state of the art closest to the substantially upright surface-adhering self pleasure device and method.

Patent Citation 1, illustrates a male masturbation device for discreet sperm collection. This device has recently been marketed (product name: Fleshlight) with a means of attachment to adhere to a wall comprising a suction mount mechanism with an articulating means that is threaded and screwed on to the hard case of the device. This means of attachment is complex and requires user assembly. This masturbation device having a hard case lacks comfort during use, allows for possible injury if the device dislodges and falls onto the user, is comprised of a number of components and has many components to assemble/disassemble and clean. The means of attachment is a considerable distance away from the point of entry, which places a considerable amount of stress on both the device and the means of attachment causing the masturbation device to be at a higher risk of failure and/or dislodgement during use. Furthermore, the device is limited to having only one channel and is not designed to roll up into a sleeve masturbator nor to roll up for discrete storage.

Patent Citation 2, illustrates a sexual aid that is affixed to the torso of a person and is used to guide a penis within a passageway. Additionally, masturbation sleeves are common prior art (e.g. Patent Citation 3) which are used for self pleasure. These sexual aids are not engineered for hands-free masturbation nor do they adhere to substantially upright surfaces without an external or an additional means of attachment, nor are they designed to roll up into a sleeve masturbator, nor are they designed to roll up for discrete storage.

### SUMMARY

### Technical Problem

There is a need for a simple, safe, comfortable and non-user assembled sexual aid device designed to adhere to a substantially upright surface to provide a hands-free method for stimulation of a penis. The simple device not having a hard external shell may be rolled up into a sleeve masturbator and/or may be rolled up for discrete storage. The sexual aid device offers a low complexity, inexpensive, discrete and versatile solution to masturbation.

### Technical Solution

The substantially upright surface-adhering self pleasure device and method solves the above technical problem. The sexual aid device comprises at least one main body, at least one channel that accommodates a human penis and at least one means of attachment. Additionally, the sexual aid device has none, one, or a plurality of the following elements in various combinations and configurations comprising: protrusions, stabilizers, recesses, textures, and stimulators.

### Advantageous Effects of Invention

Accordingly, several advantageous effects of the device are to provide a masturbation device for males that:
(a) is simple, easy to use and easy to clean;
(b) is less susceptible to device failure and/or dislodgement from user applied stress;
(c) is a less complex device enabling use by dexterity challenged individuals;
(d) is not required to be placed within a hard shell case to be adhered to a surface;
(e) allows for safe and comfortable hands-free masturbation;
(f) adheres to a substantially upright surface without a threaded means of attachment;
(g) can have multiple channels;
(h) can be rolled up into a sleeve masturbator; and
(g) can be rolled up for discrete storage.

Further objects and advantages will become apparent from a consideration of the ensuing description and drawings.

### BRIEF DESCRIPTION OF DRAWINGS

FIG. 1 is a perspective view of the sexual aid device.

FIG. 2 is a side view of the device of FIG. 1.

FIG. 3 is a side view of the device of FIG. 2 in an expanded state simulating the stretching effect induced by a penis within the device.

FIG. 4 is a side view of a variation of the device FIG. 1 with an alternative means of attachment, no protrusions and having texture.

FIG. 5 is a front view of a variation of the device of FIG. 1 with alternative channels, an alternative means of attachment, alternative protrusions, and texture.

FIG. 6 is a perspective view of the device of FIG. 1 in position on the substantially upright surface of a shower stall.

FIG. 7 is a front view of a variation of the device of FIG. 1 with an alternative channel, an alternative means of attachment, an alternative protrusion, a stabilizer, recesses and a stimulator.

FIG. 8 is a cross-sectional view taken along 8-8 of the device of FIG. 7.

FIG. 9 is a front view of a variation of the device of FIG. 1 with an alternative channel, an alternative means of attachment, an additional means of attachment, an alternative protrusion, a stabilizer, and texture.

FIG. 10 is a cross-sectional view taken along 10-10 of the device of FIG. 9.

FIG. 11 is a top view of the device of FIG. 4 in a furled state.

FIG. 12 is a top view of the device of FIG. 11 in a more tightly furled state.

FIG. 13 is a perspective view of the device of FIG. 12 placed into a storage container.

### DESCRIPTION OF EMBODIMENTS

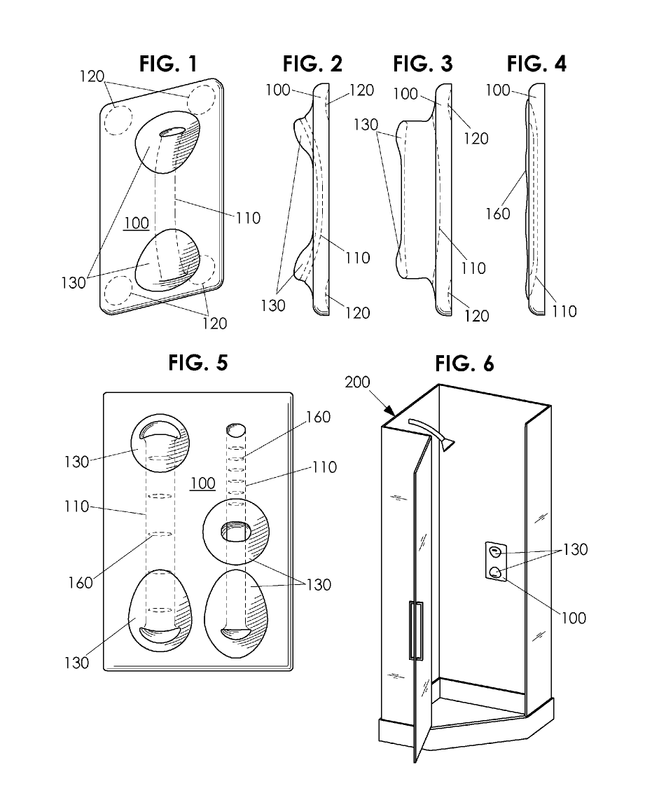

As illustrated in FIGS. 1-13, a substantially upright surface-adhering self pleasure device and method comprises: at least one main body 100, at least one channel 110, at least one means of attachment 120 and none, one or a plurality of protrusions 130, stabilizers 140, recesses 150, textures 160, and stimulators 170. This simple device, when adhered to a substantially upright surface, allows a male to safely and comfortably perform hands-free stimulation to the penis.

Main Body 100—As illustrated in FIGS. 1-8 the device has a main body 100. The main body 100 generally resembles a rectangle. The main body 100 is sized and shaped to comprise a channel 110 and to allow the device to adhere via a means of attachment 120 to a substantially upright surface allowing for hands-free stimulation to the penis while resisting delamination or displacement. The main body 100 can be rolled up for storage as in FIG. 13.

Alternatively, as in FIGS. 9-10, the main body 100 can be oblong-shaped.

Alternatively, as in FIGS. 11-12, the main body 100 can be coiled and held in the user's hand to create a masturbation sleeve. The main body 100 can be loosely coiled (FIG. 11) or tightly coiled (FIG. 12) to provide the user with different sensations.

Variations of the main body 100 comprise: various sized and shaped main bodies; main bodies with various cross-sectional geometry; main bodies with varying thicknesses; main bodies with edges of varying thicknesses; main bodies that allow the orientation of the channel to be at any angle; main bodies comprised of multiple pieces; main bodies shaped to accommodate placement on irregularly shaped surfaces, such as a soap holder, a rack, door knob, etc.; main bodies that are elliptical, square, diamond-shaped, generally round, polygonal, hourglass-shaped, triangular, irregular-shaped and combinations thereof etc.; main bodies comprising any shape that supports the functions of adhering to a substantially upright surface and resisting delamination and/or displacement. The main body has one or a plurality of channels, one or a plurality of means of attachment, none, one or a plurality of protrusions, stabilizers, recesses, textures, and stimulators. The device has at least one main body.

Channel 110—As illustrated in FIGS. 1-4, 6-10, the device has a channel 110. The channel 110 has an elliptically shaped cross-section and the length of the channel 110 generally aligns with the length of the main body 100. The channel 110 is sized and shaped to be a passageway for the movement of a penis. FIGS. 1-8 illustrate channels 110 that are open at both ends of the device.

Alternatively, as in FIG. 5, the device has two channels 110: one larger channel 110 with an elliptically shaped cross-section having a textured 160 surface and a second channel 110 with an elliptically shaped narrower cross-section. One channel 110 has a mid-length opening and has texture 160 on a portion of the channel 110.

Alternatively, the channel 110 can have a wave-shape and can have a closed end as in FIG. 9.

FIGS. 1-8, 11-13, illustrate devices that have a channel that is open at either end allowing lubrication to be more easily applied within the channel 110.

In FIG. 3, the channel 110 is in an expanded state to illustrate how the material stretches when a penis is within the channel 110. This illustration serves to highlight the elastic flexural nature of the material.

Variations of the channel 110 comprise: channels with various cross-sectional shapes comprising: circular, elliptical, polygonal, arc-shaped, crescent-shaped or irregular shapes, and combinations thereof, etc.; channels that are straight, arced, parabolic, wavy, or irregular in direction and combinations thereof, etc.; channels with various entry and/or exit lip geometry configurations; channels with or without texture; channels with none, one, or a plurality of holes, entrances and/or exits; channels that intersect each other; channels that connect to other elements of the device; channels oriented at various angles relative to the main body; channels with a reservoir end or a closed end or an open end and/or any combinations thereof; and any channel that is sized and shaped to be a passageway for movement of a penis within the device. The device has at least one channel.

Means of Attachment 120—As illustrated in FIGS. 1-3, the device can have removed portions of material that serve as suction cups, providing a built-in means of attachment 120 for securing the device to a substantially upright surface. The means of attachment 120 serves to secure the device to a substantially upright surface.

Alternatively, FIGS. 4-5, 7-8, illustrate the device having a flat surface. The material's tackiness acts as a means of attachment 120 for securing the device to a substantially upright surface.

Alternatively, FIGS. 9-10, illustrate the device having an additional means of attachment 120; the device has suction cups connected to a removed portion of material within the main body 100 and the protrusions 130. When the removed portion of material from within the protrusion 130 is pressed and released with a body part or object, the material's natural tendency to spring back to its original shape creates additional vacuum pressure within the suction cups to aid in adhering the device to the surface.

Variations of the means of attachment 120 comprise: external or built-in means of attachment; various sized removed portions of material serving as suction means; external suction cups comprising: clipped on suction cups and suction cups attached to the device by any means; any alternative methods of securing the device in any angled position to the substantially upright surface comprising: bands, holding with hands, friction holds, material tackiness, tapes, adhesives, straps, buttons, hook and loop fasteners, ties, rings, snaps, zippers, etc. The device has at least one means of attachment.

Protrusion 130—As illustrated in FIGS. 1-3, 5-10, the device can have an extended portion of material attached to the main body 100: the protrusion 130. The protrusion 130 is located on the main body 100 opposite to the surface of the device which adheres to the substantially upright surface. The protrusion 130 is dimensioned to provide additional structure to the entrance and/or exit and/or length of the channel 110, can be used to modify the pressure to the genital area or torso and can allow the channel 110 entrance to have various angles for ease of penetration.

Variations of the protrusion 130 comprise: various sized protrusions; protrusions with various cross-sectional geometry comprising: round (FIG. 5), elliptical, irregular, polygonal, crescent-shaped and combinations thereof; protrusions in various positions on the device; protrusions comprised of multiple pieces; protrusions having a recess; protrusions having an appearance to simulate human body parts; protrusions with varying thicknesses; protrusions extending onto the edge of the main body; and any protrusion serving to aid in reinforcing a channel entrance or the length of a channel; protrusions having none, one or a plurality of recesses, means of attachment, stabilizers, textures, and stimulators. The device can have none (FIGS. 4, 11-12), one or a plurality of protrusions.

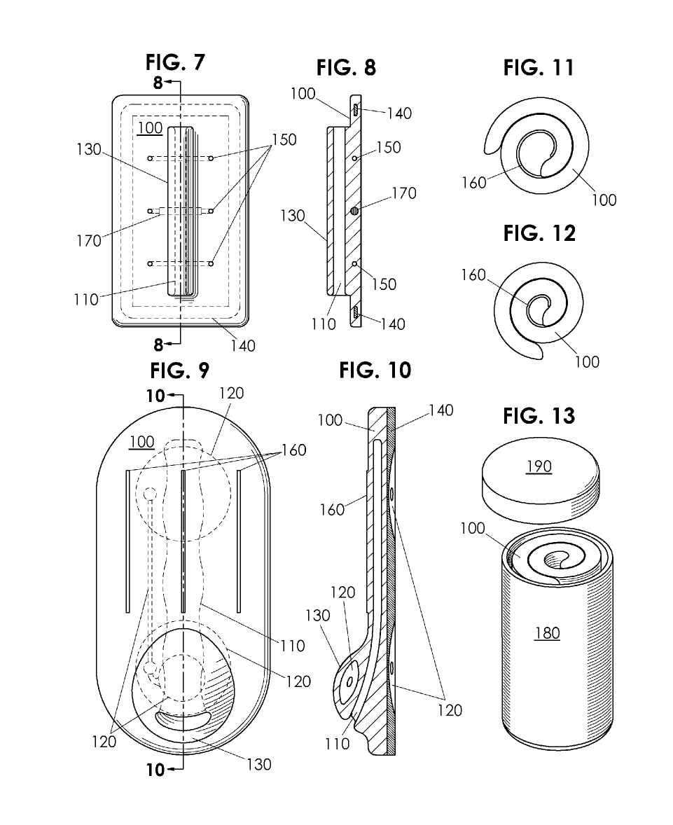

Stabilizer 140—As illustrated in FIGS. 7-10, the device can have a stabilizer 140. FIGS. 7-8 illustrate an embedded stabilizer 140 within the main body 100 of the device. This stabilizer 140 resembles a rectangular frame having an oblong cross-section. FIGS. 9-10 illustrate a laminated stabilizer 140, where the stabilizer 140 is a layer of the device. The stabilizer's 140 material flexural properties are stronger than the parent device's material properties. The stabilizer 140 serves to add structure and rigidity to the device to resist movement during use and the stabilizer 140 can serve to better transmit stimulation from a stimulator 170.

Variations of the stabilizer 140 comprise: various sized stabilizers; stabilizers of varying shapes comprising: round, polygonal, crescent-shaped, irregular, elliptical, and combinations thereof; stabilizers with various cross-sectional geometry comprising: round, polygonal, crescent-shaped, irregular, elliptical, and combinations thereof; stabilizers of varying thicknesses; stabilizers made with multiple materials; stabilizers comprised of multiple pieces; stabilizers on any surface of or embedded within any part of the device and combinations thereof; stabilizers that serve to aid in maintaining, reinforcing and supporting the shape of any part of the device and/or serve to transmit stimulation from a stimulator. The device can have none, one, or a plurality of stabilizers.

Recess 150—As illustrated in FIGS. 7-8, the device can have a removed portion of material: a recess 150. The recess 150 can be sized and shaped to support a stimulator 170. A stimulator 170 can be positioned into a desired recess 150. The recess 150 is designed to hold and support stimulators 170 comprising: vibrating devices, pulsating devices, pellet-rotating devices, oscillating devices, heating devices, hard objects, suction devices, motorized devices or any means of stimulation. With the correct choice of materials for the device, the vibrations, pulses, heating, and/or properties from stimulators 170 can be transmitted throughout the device or in localized regions.

Variations of the recess 150 comprise: recesses piercing through the entire device; recesses having various cross-sectional geometry comprising: circular, elliptical, polygonal, arc-shaped, crescent-shaped or irregular shapes, and combinations thereof, etc.; recesses that are straight, arced, parabolic, wavy, or irregular in direction and combinations thereof, etc.; recesses with various shaped entry and/or exit geometry configurations; recesses with or without texture; recesses with none, one, or a plurality of access holes; recesses that connect to other elements of the device; recesses oriented at various angles; any recess that is dimensioned to create a void on or within the device for holding none, one, or a plurality of stimulators. The device can have none, one, or a plurality of recesses.

Texture 160—As illustrated in FIGS. 4-5, 9-12, the device can have texture 160. This texture 160 is shown as raised ridges. The texture 160 can serve to aid in the adhering of the device to the surface, transmitting, reducing and/or enhancing stimulation.

Variations of texture 160 comprise: round half spheres, dimples, finger-like projections, wave-like ridges, any means of changing the feel, tackiness, flexibility or consistency of any surface. The device can have texture.

### Material

The device, not including any stabilizers 140, is made of at least one elastomeric material comprising: silicones, rubbers, elastomeric gels, etc. The elastomeric material for the device has a durometer between 1-30 on the Shore 00 scale of hardness. However, the device can be made with any material that comprises the following characteristics. The material should be soft, elastic, flexible and deformable by human fingers without permanent deformation and capable of multiple washings without deterioration. The material should also have the density and tactile feel of human flesh and be capable of readily transmitting sensations throughout.

The material can be tacky to the touch. This tackiness can allow the device to adhere to a substantially upright surface.

An additional material can be required for a stabilizer 140. The preferred material for the manufacture of a stabilizer 140 is at least one elastomeric material comprising: silicones, rubbers, elastomeric gels, etc. with a durometer between 1-70 on the Shore A scale of hardness. The stabilizer 140 is preferably constructed from a similar material with similar properties used for the device, albeit more rigid. The rigidity of the stabilizer 140 is dependent upon the shape, thickness and the durometer of the material used. A thicker stabilizer 140 having a lower durometer material can have the same rigidity and flexural properties as a thinner stabilizer 140 having a higher durometer material. Material with durometers outside of the stated preferred range of durometers can be used depending on the shape, geometry and required characteristics for the stabilizer 140. Alternatively, the stabilizer 140 can be made of any type of material comprising: metal, plastic, etc. that is more rigid than the material for the device.

### Manufacturing

The device and/or the stabilizer 140 are molded using conventional injection molding techniques and technologies. Devices with a stabilizer 140 (FIGS. 7-8) are manufactured using conventional injection over-molding/co-molding techniques and technologies.

### Operation

As illustrated in FIG. 6, the device is placed against a substantially upright surface (shown here as a shower stall 200), and positioned such that a channel 110 can be penetrated by a penis. Lubrication is applied within a channel 110 and the device can then be penetrated. Alternatively, the masturbator can be used by hand in a coiled configuration with lubrication being applied to the area of the device that will be penetrated. After use, the device is removed from the substantially upright surface, washed, and can be coiled for storage in a storage container 180 with storage container top 190, pocket, bag, towel etc.

### CONCLUSION, RAMIFICATIONS AND SCOPE

While the above figures contain many specificities, the reader should not construe these as limitations on the scope of the invention, but merely as exemplifications of several preferred embodiments thereof. Various other embodiments are possible. Further embodiments of the substantially upright surface-adhering self pleasure device comprising various configurations of the variations described for each element in the specification are possible. These element variations comprise variations of: main bodies, channels, means of attachment, protrusions, stabilizers, recesses, textures and stimulators. Different flexible and resilient materials can be used for the device. The device can be used by a single user, couples or multiple users. The device can have insertable channel sleeves with altered textures. The device can be connected to a liquid supply. The device can be manufactured from an edible material. Pigments, scents, pharmacological compounds or transdermal medication can be placed onto or added to the material of the device. The device can be designed and constructed to be symmetrical or asymmetrical and can be made of multiple materials and multiple pieces. The device can be built into or positioned on walls or on variously angled surfaces. Optionally, tentacle-like protrusions, offering additional stimulation, spanning from the device can be added. This device can be reusable, disposable and/or recyclable. The reader can see that the device provides users with a new, comfortable, safe and discrete means to masturbate.

### INDUSTRIAL APPLICABILITY

According to the sexual aid device related to the invention, it is possible for a male to perform safe and comfortable hands-free stimulation to the penis with the aid of the said low complexity device adhered to a substantially upright surface.

### REFERENCE SIGNS LIST

100 main body
110 channel
120 means of attachment
130 protrusion
140 stabilizer
150 recess
160 texture
170 stimulator
180 storage container
190 storage container top
200 shower stall

### CITATION LIST

Patent Citation 1: U.S. Pat. No. 5,782,818 (SHUBIN, S) 1998 Jul. 21

Patent Citation 2: WO/2012/149647 Amended Version (MAURETTE, N) 2012 Nov. 8

Patent Citation 3: JP 2005-168908 (MATSUURA, T) 2005 Jun. 8

1. A sexual aid article comprising:
a) a main body,
b) at least one non-threaded means of attachment, affixing the main body to a substantially vertical inanimate surface,
c) at least one channel, defined in a portion of the main body,
wherein the portion of the main body is made of at least one elastomeric material, and
the at least one channel is dimensioned to accommodate a human penis, and
whereby, the human penis is stimulated when moved within the at least one channel.

2. The sexual aid article of claim 1, wherein the main body is dimensioned to be rolled up.

3. The sexual aid article of claim 1, wherein the main body further comprises at least one protrusion.

4. The sexual aid article of claim 1, further comprising at least one recess.

5. The sexual aid article of claim 4, wherein the at least one recess further comprises at least one stimulation means.

6. The sexual aid article of claim 1, further comprising at least one stabilizer wherein the at least one stabilizer comprises a portion of more rigid material of the sexual aid article.

7. A method for stimulating a penis, comprising:
a. providing a masturbator of the type comprising
a main body,
at least one non-threaded means of attachment, affixing the main body to a substantially vertical inanimate surface,
at least one channel, defined in a portion of the main body,
wherein the portion of the main body is made of at least one elastomeric material, and the at least one channel is dimensioned to accommodate a human penis, and
b. positioning the masturbator on the substantially vertical inanimate surface,
whereby, the human penis is stimulated when the at least one channel is penetrated.

8. The method of claim 7, wherein the main body further comprises at least one protrusion.

9. The method of claim 7, further comprising at least one recess.

10. The method of claim 9, wherein the at least one recess further comprises at least one stimulation means.

11. The method of claim 7, further comprising at least one stabilizer wherein the at least one stabilizer comprises a portion of more rigid material of the masturbator.

12. The method of claim 7, wherein the main body is dimensioned to be rolled up.
